(19) United States
(12) Patent Application Publication
(10) Pub. No.: US 2013/0151331 A1
(43) Pub. Date: Jun. 13, 2013

(54) SYSTEM AND METHODS THEREOF FOR AN ADAPTIVE LEARNING OF ADVERTISEMENTS BEHAVIOR AND PROVIDING A RECOMMENDATION RESPECTIVE THEREOF

(71) Applicant: Taykey Ltd., Herzliya (IL)

(72) Inventors: Amit AVNER, Herzliya (IL); Omer DROR, Tel Aviv (IL); Eran EIDINGER, Tel Aviv (IL)

(73) Assignee: TAYKEY LTD., Herzliya (IL)

(21) Appl. No.: 13/761,247

(22) Filed: Feb. 7, 2013

Related U.S. Application Data
(63) Continuation-in-part of application No. 13/482,473, filed on May 29, 2012.
Application No. 13/482,473 is a continuation-in-part of application No. 13/279,673, filed on Oct. 24, 2011.
Application No. 13/279,673 is a continuation-in-part of application No. 13/050,515, filed on Mar. 17, 2011.
Application No. 13/050,515 is a continuation-in-part of application No. 13/214,588, filed on Aug. 22, 2011.
(60) Provisional application No. 61/733,472, filed on Dec. 5, 2012.
(60) Provisional application No. 61/316,844, filed on Mar. 24, 2010.

(51) Int. Cl. G06Q 30/02

(52) U.S. Cl. CPC G06Q 30/0244; G06Q 30/0242
USPC 705/14.41

(57) ABSTRACT

A system and method for adaptive learning of at least one advertisement behavior. The method comprises receiving electronically at least one advertisement and associated metadata from a client node over a network; continuously monitoring the behavior of the at least one advertisement; analyzing the performance of the at least one advertisement; and determining the future performance of the at least an advertisement respective of the analysis.

### CROSS REFERENCE TO RELATED APPLICATIONS

This application claims the benefit of US Provisional Application No. 61/733, 472 filed Dec. 05, 2012. The application is also continuation-in-part of:
1. U.S. patent application Ser. No. 13/482,473 filed on May 29, 2012;
2. U.S. patent application Ser. No. 13/279,673 filed on Oct. 24, 2011;
3. U.S. patent application Ser. No. 13/050,515, filed on Mar. 17, 2011 which claims the benefit of US provisional application No. 61/316,844 filed on Mar. 24, 2010; and
4. U.S. patent application Ser. No. 13/214,588, filed on Aug. 22, 2011. The contents of each of the above-referenced applications are incorporated herein by reference.

### TECHNICAL FIELD

The invention generally relates to a system for managing a campaign, and more specifically to system and methods for monitoring the behavior of an advertisement over the web and providing recommendations respective thereof.

### BACKGROUND

The ubiquity of access availability to information using the Internet and the worldwide web (WWW), within a short period of time, and by means of a variety of access devices, has naturally drawn the focus of advertisers. The advertisers may pay publishers such as search engines, for example, Google® or Yahoo!®, for the placement of their advertisement when a related keyword to said advertisement is submitted by a user for a search. Other publishers may be social networks, such as Facebook®, Google+®, and Linked In® that further allow placement of advertisements for a fee.

Each of the advertisement publishers provides a unique application programming interface (API) through which a user wishing to place an advertisement, or bidding for a placement respective thereof, is expected to use. As on-line advertising continuously changes and develops, with more publishers becoming available and utilizing many different types of unique APIs, it has become difficult to monitor the performance of a campaign. Furthermore, it has become difficult to predict the efficiency at the starting point of the campaign due to the plurality of variables needed to be considered.

It would therefore be advantageous to overcome the limitations of the prior art by providing an effective way to monitor the performance of a campaign. It would be further advantageous to overcome the limitations of the prior art by providing an effective way to predict a future performance of a campaign.

### SUMMARY

Certain embodiments disclosed herein include a method for adaptive learning of at least one advertisement behavior. The method comprises receiving electronically at least one advertisement and associated metadata from a client node over a network; continuously monitoring the behavior of the at least one advertisement; analyzing the performance of the at least one advertisement; and determining the future performance of the at least an advertisement respective of the analysis.

Certain embodiments disclosed herein also include an apparatus for an adaptive learning of at least one advertisement behavior. The apparatus comprises an interface to a network for receiving and sending data over the network; a client node coupled to the network; a database coupled to the network; a processing unit coupled to the network; and a memory coupled to the processing unit that contains therein instructions that when executed by the processing unit configures the apparatus to: receive electronically at least one advertisement and associated metadata from a client node over the network; and, continuously monitor the behavior of the at least one advertisement; analyze the performance of the at least one advertisement; determine the future performance of the at least an advertisement respective of the analysis.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1—is a schematic diagram of a system in accordance with an embodiment;

FIG. 2—is a flowchart describing the operation of the system in accordance with an embodiment; and,

FIG. 3—is graph describing the monitoring of an advertisement in accordance with an embodiment.

### DETAILED DESCRIPTION

The embodiments disclosed by the invention are only examples of the many possible advantageous uses and implementations of the innovative teachings presented herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

A system monitors in real-time the performance of an advertisement over the web. The system analyzes the performance of the advertisement and provides tools for optimal management of an advertisement budget in real-time. In one embodiment the system is capable of predicting the behavior of an advertisement and providing recommendations respective thereof.

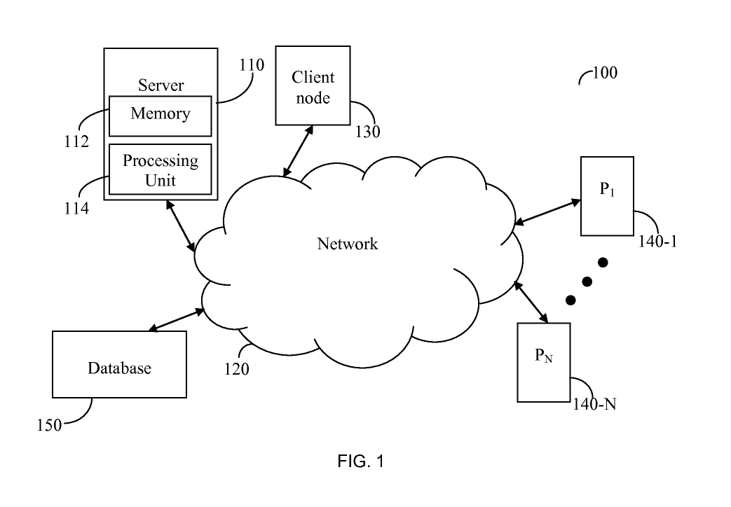

FIG. 1 depicts an exemplary and non-limiting schematic diagram of a system 100 in accordance with an embodiment. A server 110, such as, but not limited to, a computer comprising of a processing unit 114 which is coupled to an internal memory 112, where the server 110 is connected to a network 120. The server 110 is configured to receive requests for placements of advertisements which include the advertisement itself and metadata associated thereto, and responsively after, interfacing with the requested publisher node to place the request advertisement. The network 120 can be wired or wireless, a local area network (LAN), a wide area network (WAN), a metro area network (MAN), the Internet, the worldwide web (WWW), the likes, and any combinations thereof. The memory 112 contains instructions that when executed by the processing unit 114 configure the server 110 to perform the functions described herein below. The server 110 receives a request to publish an advertisement with at least a publisher node from the plurality of publisher nodes 140-1 through 140-N, and associated metadata from a client node, for example, client node 130. Responsive thereto, the server 110 is configured to monitor in real-time the behavior of the published advertisement and analyze the advertisement's performance.

According to one embodiment, in order to analyze the performance of a single advertisement, the server 110 monitors the output of the advertising platform, for example, the budget spent and the volume of impressions collected from users that view or responded to the published advertisement. The server 110 is then configured to recalculate and suggest a better input, for example, a better budget split. According to another embodiment the server 110 tracks the non-time-invariant behavior of the published advertisement. The tracking of the non-time invariant behavior of the published advertisement is necessary because the volume of impressions through time is heavily affected by the presence of crowd routine viewing the advertisement through time. As an example, the more people are on Facebook®, the more ad-spaces are available. Furthermore, as the advertisement price is usually determined based on a bid, additional circumstances must be considered in order to achieve an optimal performance. Such circumstances may relate to the common behavior of web advertising, for example, while approaching end of quarter advertisers tends to increase the advertisement. Other example is that most of the advertisers do not work weekends. In order to track the non-time-invariant behavior of the published advertisement, the server 110 identifies the volume of impressions received respective the published advertisement within a specific location considering the local time in that location.

The behavior of the published advertisement together with the respective analysis is saved in a database 150 for future use. The accumulative data stored in the database 150 may further be used by the server 110 to determine and predict a publisher's behavior. As a non-limiting example, by analyzing the costs for publishing a specific type of advertisements with Facebook® over time, the server 110 may identify that at the end of every quarter, the costs for publishing such type of advertisements is higher. Respective of such identification the server 110 is capable of profiling the behavior of Facebook® and provide recommendations respective thereof.

The server 110 is then capable of providing one or more recommendations for optimal management of the advertisement. It should be understood that while a single client node 130 is shown in FIG. 1, this should not be viewed as limiting on the invention, and one of ordinary skill in the art would readily appreciate that additional client nodes can be added without departing from the spirit and/or scope of the invention. In another embodiment of the invention the one or more recommendations are automatically executed by the server 110 without further intervention by a user of the client node 130.

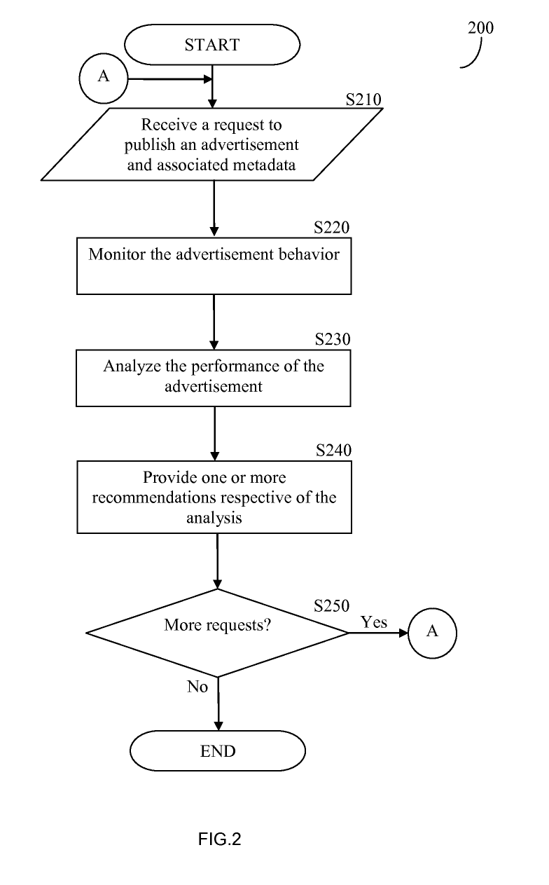

FIG. 2 depicts an exemplary and non-limiting flowchart 200 describing the operation of the system in accordance with an embodiment. In S210, a server, for example the server 110, receives a request to publish an advertisement from a client node, for example the client node 130, and associated metadata respective of the advertisement. Such metadata may be the targeted audience, a multimedia content to be displayed, budget constraints, preferred publishers, preferred advertising platforms, preferred times, etc. In one embodiment the server 110 may further receive from the user of the client node 130 expectations or requirements respective of the advertisement. In S220, the server 110 monitors the behavior of the published advertisement in real-time. The behavior may be related to an advertising platform's outputs. Such advertising platform's outputs may be but are not limited to at least one of: audience impression related to the advertisement, amounts of clicks on a multimedia content in the advertisement, conversions from the advertiser's website, etc. The monitoring is continuously performed as the platform's outputs may be unevenly spaced through time. In S230, the server 110 analyzes the performance of the published advertisement. The analysis may be made respective of the requirements determined by the user or respective of one or more statistical parameters which are based on experience related to one or more similar advertisements. According to one embodiment, respective of the analysis, the server 110 is configured to determine the future performance of the advertisement. In S240, the server 110 is configured to provide a recommendation for optimal management of the advertisement respective of the analysis. The recommendation may comprise the process of: calculating a recommendation, display a recommendation, operating the system 100 respective of a recommendation and a combination thereof. Such recommendation may relate to the split of the budget, the time of the day, the week or the month the advertisement is published, changes in the bidding and/or bidding strategy on the ad space, changes on the budget spent on every variation of the ad, changes in the budget spent on every variation of the targeting parameters of the ad, etc. In S250, it is checked whether there are more requests and if so, execution continues with S210; otherwise, execution terminates. It should be understood that the server 110 is further capable of monitoring and analyzing a campaign comprising a plurality of advertisements and provide recommendations respective thereto as further described hereinabove. According to another embodiment, the server 110 is capable of predicting the future behavior of an advertisement respective of data stored in a database, for example the database 150, and provide recommendations respective thereto.

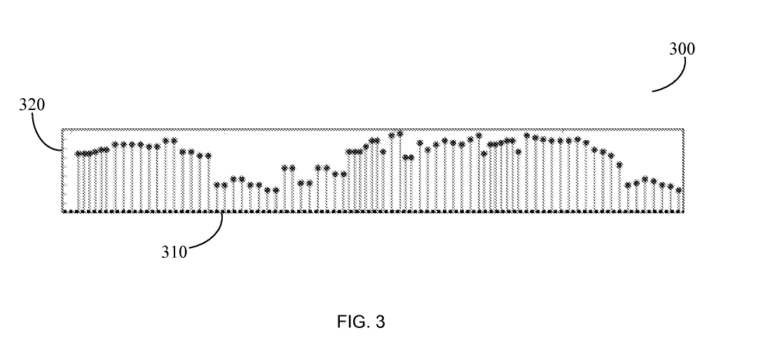

FIG. 3 depicts an exemplary and non-limiting graph 300 describing the monitoring of an advertisement in accordance with an embodiment. The horizontal axis 310 uses a predetermined time frame's resolution where the server 110 monitors the amount of clicks on the advertisement. The vertical Axis 320 of the graph 300 shows the amount of clicks on the advertisement over the predetermined time frames (labeled as 310). The server 110, by continuously analyzing of the amount of clicks on the advertisement over time, instantly identifies the changes of the delivery rate respective of the advertisement over the course of a day. Respective thereto the server 110 is capable of recommending when to increase or decrease a bid respective of the advertisement during the course of the day. According to another embodiment, the server 110 can further predict the behavior of an advertisement by comparing the behavior of one or more advertisements which have related metadata. According to another embodiment a publisher, for example, Facebook®, may require a mandatory decrease in a bid respective of an advertisement upon meeting a certain threshold. Such requirement may occur when the provider wishes to optimize the user experience for the targeted audience and prevent users from viewing the same advertisements periodically. In such embodiment the server 110, is capable of identifying a common pattern related to such mandatory requirement received from a provider and provide a real-time recommendation regarding the allocation of the budget while avoiding reaching such a threshold. The various embodiments of the invention are implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

1. A computerized method for adaptive learning of at least one advertisement behavior, the method comprising:
receiving electronically at least one advertisement and associated metadata from a client node over a network;
continuously monitoring the behavior of the at least one advertisement;
analyzing the performance of the at least one advertisement; and
determining the future performance of the at least an advertisement respective of the analysis.

2. The computerized method of claim 1, wherein monitoring the behavior of the at least one advertisement further comprises:
tracking the non-time-invariant behavior of the at least one advertisement.

3. The computerized method of claim 2, further comprising:
storing the behavior of the at least one advertisement and the respective analysis of the performance of the at least one advertisement in a database.

4. The computerized method of claim 1, further comprising:
providing at least one recommendation respective of the analysis of the at least one advertisement performance.

5. The computerized method of claim 1, wherein the associated metadata is at least one of: targeted audience, a multimedia content to be displayed, budget constraints, preferred publishers, preferred advertising platforms, preferred times.

6. The computerized method of claim 4, wherein the providing a recommendation is one of: calculating a recommendation, displaying a recommendation, implementing a recommendation or a combination thereof.

7. The computerized method of claim 6, wherein the recommendation is at least one of: changes in the bidding, changes in the bidding strategy, optimized split of the budget, optimized time of the day, optimized time for publishing the advertisement.

8. A non-transitory computer readable medium having stored thereon instructions for causing one or more processing units to execute the method according to claim 1.

9. A system comprising one or more processing units and one or more memory units coupled to the one or more processing units; at least one of the one or more memory units storing therein instructions for causing one or more processing units to execute the method according to claim 1.

10. An apparatus for an adaptive learning of at least one advertisement behavior comprising:
an interface to a network for receiving and sending data over the network;
a client node coupled to the network;
a database coupled to the network;
a processing unit coupled to the network; and
a memory coupled to the processing unit that contains therein instructions that when executed by the processing unit configures the apparatus to: receive electronically at least one advertisement and associated metadata from a client node over the network; and, continuously monitor the behavior of the at least one advertisement; analyze the performance of the at least one advertisement; determine the future performance of the at least an advertisement respective of the analysis.

11. The apparatus of claim 10, wherein the monitor further comprises:
tracking the non-time-invariant behavior of the at least one advertisement.

12. The apparatus of claim 11, further comprises a database coupled to the network.

13. The apparatus of claim 10, wherein the memory further contains instructions that configure the apparatus to store the behavior of the at least one advertisement and the respective analysis of the performance of the at least one advertisement in the database.

14. The apparatus of claim 10, wherein the memory further contains instructions that configure the apparatus to provide at least one recommendation respective of the analysis of the at least one advertisement performance.

15. The apparatus of claim 10, wherein the associated metadata is at least one of: targeted audience, a multimedia content to be displayed, budget constraints, preferred publishers, preferred advertising platforms, preferred times.

16. The apparatus of claim 14, wherein providing the recommendation further includes at least one of: calculate a recommendation, display a recommendation, implement a recommendation or a combination thereof.

17. The apparatus of claim 11, wherein the recommendation is at least one of: changes in the bidding, changes in the bidding strategy, optimized split of the budget, optimized time of the day, optimized time for publishing the advertisement.
